(19) United States
(12) Patent Application Publication
(10) Pub. No.: US 2024/0127315 A1
(43) Pub. Date: Apr. 18, 2024

(54) APPARATUS AND METHOD FOR BUILDING A SHOPPING LIST WITH A SENSOR UNIT

(71) Applicant: Walmart Apollo, LLC, Bentonville, AR (US)

(72) Inventor: Daniel B. Howell, Bentonville, AR (US)

(21) Appl. No.: 18/392,918

(22) Filed: Dec. 21, 2023

Related U.S. Application Data
(63) Continuation of application No. 15/329,762, filed on Jan. 27, 2017.
(60) Provisional application No. 62/029,978, filed on Jul. 28, 2014.

(51) Int. Cl. G06Q 30/0601; G06Q 20/12; G06Q 20/20; G06Q 20/32; G07G 1/00; G07G 1/14

(52) U.S. Cl. CPC G06Q 30/0635; G06Q 20/123; G06Q 20/202; G06Q 20/208; G06Q 20/3223; G07G 1/0081; G07G 1/14

(57) ABSTRACT

Systems, apparatuses and methods are provided herein for building a shopping list on a user device using a sensor unit attached to a shopping container. In one embodiment, a shopping apparatus is provided. The shopping apparatus includes a portable item container and a sensor unit attached to the portable item container. The sensor unit includes a sensor configured to detect identifying information from items gathered by a user and placed in the portable item container and a transmitter configured to wirelessly transmit the identifying information of the items to a user device configured to use the identifying information to build a shopping list.

### RELATED APPLICATION(S)

This application is a continuation of U.S. patent application Ser. No. 15/329,762, filed Jan. 27, 2017 and claims the benefit of priority to International Application No. PCT/US2015/042438, filed Jul. 28, 2015 and U.S. Provisional Application No. 62/029,978, filed on Jul. 28, 2014, and the disclosures of which are incorporated by reference herein in their entirety.

### TECHNICAL FIELD

This invention relates generally to method and apparatus for building a shopping list of items collected by a shopper while shopping.

### BACKGROUND

Typically, a shopper in a retail store gathers items he/she wishes to purchase into a shopping cart or a shopping basket as he/she moves around the store. When all the items are gathered, the shopper approaches a checkout counter to have each item in the shopping cart/basket scanned by a store clerk to pay for the items. Having to wait in the checkout line is often an inconvenience to shoppers. Adding more checkout terminals to reduce the wait time adds to the operating cost of the retail store. Recently, self checkout terminals have been implemented to reduce the wait time in some retail stores. However, the process of removing and scanning each item in a shopping basket/cart is still time consuming whether clerk operated or self checkout terminals are used.

### BRIEF DESCRIPTION OF THE DRAWINGS

Disclosed herein are embodiments of apparatuses and methods for building a shopping list with a sensor unit on a shopping container. This description includes drawings, wherein:

FIG. 1 is a block diagram of a system in accordance with several embodiments.

FIG. 2 is a flow diagram of a method in accordance with several embodiments.

FIG. 3 is a block diagram of a system utilizing conductive ink pattern based sensing technology in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

One method for facilitating faster checkout time in a retail store is to provide a shopping application on mobile phones such that shoppers can scan items with their phones for purchase prior to approaching a checkout counter. However, having to handle and operate a mobile phone in addition to selecting merchandise and carrying a shopping basket or pushing a shopping cart is often difficult and inconvenient for a shopper.

Generally speaking, pursuant to various embodiments, systems, apparatuses and methods are provided herein to build a shopping list with a sensor unit attached to a portable item container. The sensor unit includes a sensor that is configured to detect identifying information from items gathered by a user and placed in the portable item container. The sensor unit further includes a transmitter configured to wirelessly transmit the identifying information of the items to a user device configured to use the identifying information to build a shopping list. A sensor unit attached to a portable container allows a shopper to build a shopping list with an application running on the user device without having to constantly handle the user device. The user device may be holstered or stowed, for example, in a shopper's pocket or bag, while receiving identifying information of items the shopper gathers into a shopping container from the sensor unit. This allows the user to only handle products and the shopping container while looking for products to purchase in a store. Building the shopping list on the user device instead of on the sensor unit can also reduce the processing power and storage capacity requirements for the sensor unit and significantly reduce the cost of making the unit. The shopping list built with the shopping application on the user device may later be used to facilitate checkout for the purchase of the items gathered into the shopping container.

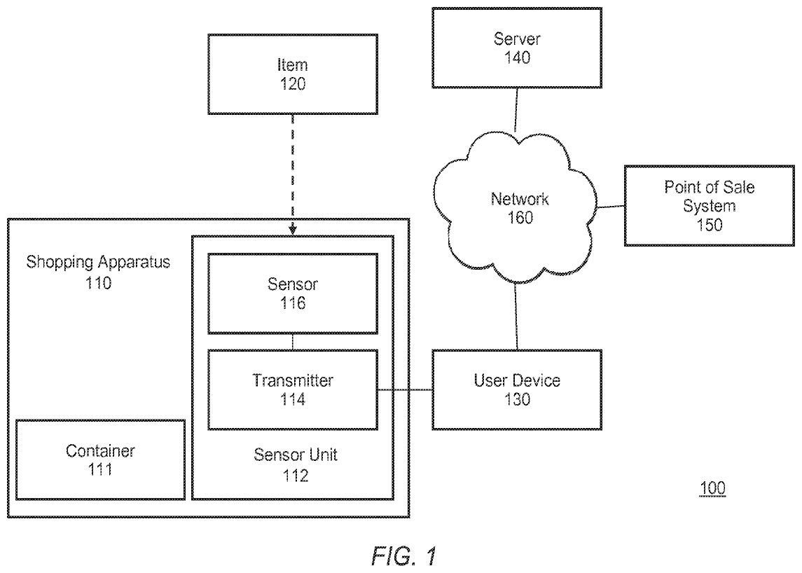

Referring now to FIG. 1, a system 100 for building a shopping list with a sensor unit according to some embodiments is shown. The system 100 includes a shopping apparatus 110, a user device 130, a server 140, and a point of sale (POS) system 150 communicating on a network 160. The shopping apparatus 110 includes a container 111 for containing and carrying one or more items including item 120 and a sensor unit 112 for detecting identifying information from one or more items.

The container 111 may be any portable container or conveyance used in a retail store, such as a basket, a cart, a bin, a bag, a pallet jack and the like. For example, the container 111 may be a shopping basket having a receptacle portion and handle portion. In some embodiments, the sensor unit 112 may be attached to a portion the container, such as the handle, through an attachment means such as an adhesive, a fastener, a magnet, a clip and the like. In some embodiments, the sensor unit 112 may be detachably attached to the container 111. For example, the sensor 116 may be attached to the container 111 though a clip or a magnet that allows the sensor unit 112 to be detached and used with another container. In some embodiments, the sensor unit 112 is integrated with the structure of the container 111. For example, the sensor unit 112 may be permanently imbedded on the rim or the handle of the container 111. In some embodiments, the sensor unit 112 or a slot for the sensor unit 112 is built into the container 111 when the container is made. In some embodiments, the container 111 is a conventional shopping container. In some embodiments, the sensor unit 112 may be brought into a store by a shopper and attached to a container 111 the shopper picks up in a store.

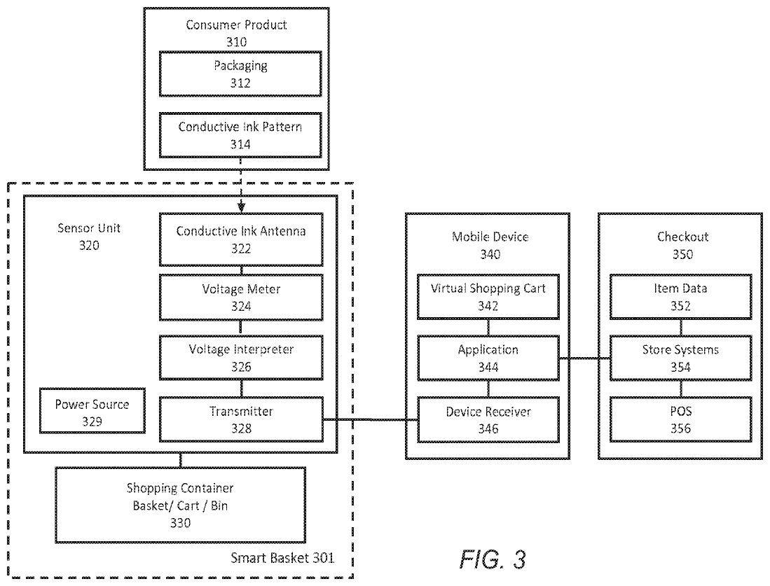

The sensor unit 112 includes a sensor 116 and a transmitter 114. The sensor 116 is configured to detect identifying information from the item 120. The sensor may be a bar code scanner, a Quick Response (QR) code reader, an optical scanner, a radio-frequency identification (RFID) reader, a near field communication (NFC) reader, a low energy Bluetooth (BTLE) reader, a camera and the like. For example, the sensor 116 may scan an identifier on the item 120, such as a bar code or RFID tag, and transmit the identifying information (e.g. Universal Product Code (UPC) or Electronic Product Code (EPC)) to the user device 130 via the transmitter 114. In some embodiments, the sensor 116 is a camera that takes a picture of the item 120 or a label on the item to send to the user device 130. In some embodiments, the sensor 116 is a conductive ink antenna configured to measure the conductivity across a conductive ink pattern on the item 120. Embodiments utilizing conductive ink patterns are described in more detail with reference to FIG. 3 below. In general, the sensor 116 may be any sensor configured to detect identifying information from the item 120, the packaging of the item 120, and/or an identifier tag on the item 120. The sensor 116 may physically contact or be in close proximity of the item 120 to detect identifying information.

The transmitter 114 may be any short-range transmitter configured to send a signal to the user device 130. In some embodiments, the transmitter is a one-way transmitter such as an optical transmitter or a FM transmitter. In some embodiments, the transmitter is a transceiver that also accepts signal from the user device 130. The transmitter may be one or more of a Bluetooth transmitter, a low energy Bluetooth transmitter, a radio frequency transmitter, a near field transmitter and the like. The transmitter 114 may broadcast an unencrypted signal at a specified frequency or transmit an encrypted signal.

The sensor unit 112 may further include a sensor unit identifier or a container identifier that provides the user device 130 information needed to receive data from the transmitter 114 of the sensor unit 112. The sensor unit identifier or the container identifier may be a number or a string of characters that is either read by the user device or entered into the user device by a user such that the user device 130 may be configured to receive communication from the transmitter 114. In some embodiments, the container identifier is a conductive ink pattern readable by a capacitive touch screen or an array of capacitive sensing circuits on the user device 130. When the user device 130 receives the container identifier, the user device 130 may retrieve a wireless frequency associated with the container identifier from a server 140 and be configured to receive a signal from the transmitter 114 at that frequency. In some embodiments a shopping application running on the user device can determine the transmission frequency based on the container identifier. In some embodiments, the container identifier is used by the user device 130 to decode the signal transmitted by the transmitter 114.

The sensor unit 112 may further include a power source for powering the sensor 116 and/or the transmitter 114. In some embodiments, the sensor unit 112 may also include a microprocessor for interpreting the signal read by the sensor 116 to convert the signal into data to be transmitted via the transmitter 114. For example, the sensor 116 may read a bar code and interpret the signal into a UPC to be transmitted. In some embodiments, the transmitter 114 transmits the signal as read by the sensor 116 directly to the user device 130 for interpretation and the sensor unit 112 does not include a microprocessor. The sensor unit 112 may further include a memory device for temporarily storing the identifying information of the item 120 prior to transmitting the information via the transmitter. In some embodiments, the identifying information stored on the memory device is purged immediately after transmission. In some embodiment, the memory device only stores identifying information for one item at a time. In some embodiments, the memory device may store a list of items and transmit the list to the user device 130 either at pre-determined intervals, when the memory storage is full, or when prompted by the user. In some embodiments, the sensor unit 112 includes no storage memory, and the identifying information of an item is read by the sensor 116 and transmitted to the user device 130 without being stored on the sensor unit 112.

The item 120 may be any product sold in a retail store such as packaged goods, produce, gift cards, etc. The item 120 may include an identifier such as a bar code, a Quick Response (QR) code, an optically readable image, a RFID tag, a NFC tag, a BTLE tag and the like. In some embodiments, the identifier may be a conductive ink pattern. In some embodiments, the identifier tag may be any passive identifier. The identifier tag may be part of the packaging of the item 120 or may be applied onto the item 120 with adhesive. The identifier generally provides unique identifying information readable by the sensor 116 that allows the user device 130 to identify the item 120 gathered by the shopper.

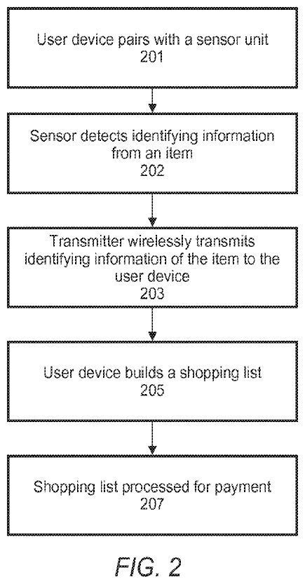

The user device 130 may be any processor-based device used by the shopper to build a shopping list. The user device 130 may be a Smartphone, a tablet computer, a wearable computer device, and the like. In general, the user device 130 includes a processor, a memory storage, and one or more input and output devices such as a touch screen. The user device 130 includes a receiver for receiving signal from the transmitter 114 of the sensor unit 112. The user device 130 further includes a network interface such as a WiFi transceiver or mobile data transceiver for communicating with a network 160. The user device 130 may have a shopping application installed on in its memory and executed by its processor. The shopping application may receive identifying information associated with multiple items and build a list of items reflecting the items in the shopping container based on the received information. The list of items built by the user device 130 may also be generally referred to as a shopping list or a virtual cart. In some embodiments, the shopping application may retrieve additional information related to the item based on the received identifying information. For example, the shopping application may retrieve item name, item description, item price, and/or applicable discount information from a server 140 based on the identifying information received from the sensor unit 112. The shopping application may display the shopping list and information related to items, such as prices, to the user. In some embodiments, the shopping application allows the user to edit the content of the shopping list. For example, a user may be able to remove an item or increase or decrease the number of items on the shopping list prior to checkout. The shopping application may further allow the user to pay for the items on the shopping list by communicating with a point of sale (POS) system 150 to process the payment for purchase. The shopping application may be a local application, a cloud-based application hosted by the server 140, or a combination of the two. A more detailed description of the shopping list building process is described below with reference to FIG. 2.

The server 140 may be a server for a specific retail store or a group of retail stores. The server 140 may include a database of items and their associated information that the user device 130 may access. The server 140 may further provide promotional information such as coupons, sale alerts, and suggestions to the user device via the shopping application. In some embodiments, item information and promotional information may be provided by the server 140 based on the location of the user device 130. For example, the user device 130 may first provide its location information to the server 140 and the server 140 would provide price and discount information specific to the retail location the shopper is in to the user device 130 based on the location information. In some embodiments, the server 140 hosts a cloud based shopping application with a user interface displayed on the user device 130. In some embodiments, the shopping list or content of the virtual cart is stored on the server 140. For example, the user device 130 may relay the identifying information of items detected by the sensor unit 112 to the server 140, which maintains a shopping list viewable on the user device 130. The server 140 may also communicate with the POS system 150 to provide the shopping list for checkout.

The point of sale (POS) system 150 may be an online or in-store checkout terminal. For example, the user device 130 may access an online checkout terminal to pay for the items in the shopping list by entering payment information through the shopping application on the user device 130. In another example, a user may approach an in-store checkout counter and have the shopping list transferred to the checkout counter to pay for the items. The user device 130 may physically contact or come in close proximity of a checkout terminal to initiate the transaction process. In some embodiments, a customer may input a POS identifier in the user device 130 or a user device identifier in the POS system 150 to transfer the shopping list to the POS system 150. In some embodiments, the shopping list is retrieved by the POS system 150 from the server 140 using an identifier associated with the user device 130 or the sensor unit 112. For example, the shopping application may display a bar code that can be scanned at a POS system 150, and the POS will retrieve information on every item on the shopping list with a single scan. In some embodiments, the shopping list may directly be transferred from the user device 130 to the POS system 150 with near filed communication (NFC) or other short range radio frequency transmission. In some embodiments, the POS system 150 may retrieve price and/or discount information for the items in the shopping list from the server 140. In some embodiments, the POS system 150 receives the total amount due for the shopping list and processes the payment for the purchase based on the total amount due. One of the server 140, the user device 130, and the POS system 150 may calculate tax and fees specific to the retail location based on the shopping list to determine the total cost of the purchase. In some embodiment, at the completion of purchase, the POS system 150 provides purchase information to the server 140 or another inventory server to update inventory information. In some embodiments, the POS system 150 or the server 140 may provide purchase receipt to the shopper electronically via the user device.

The network 160 may be one or more of the Internet, WiFi network, a mobile network, a local network, a secured network, and the like. In FIG. 1, while the server 140 and POS system 150 are shown as separate elements, in some embodiments, the server 140 and the POS system 150 may be implemented by one of more of the same devices. For example, the user device 130 may access the same server 140 to retrieve item information and to submit online payment for items on the shopping list. In another example, the server 140 and the POS system 150 are both on a local network of the retail store, and the user device 130 communicates with the server 140 and the POS system 150 through a local network.

Referring now to FIG. 2, a process for building a shopping list is shown. In FIG. 2, generally, steps 201, 205, and 207 are performed by a user device and/or a server. Steps 202 and 203 are performed by a sensor unit attached to a shopping container.

At step 201, a user device is paired with a sensor unit and/or a shopping container. In some embodiments, a user device includes a shopping application that allows a user to enter a store location and/or a container identifier to begin the list building process. In some embodiments, the container identifier may be read by a camera, a Bluetooth receiver, a NFC reader, RFID reader, or a capacitive touch screen of the user device. The container identifier allows the user to receive signal transmitted by the transmitter of the sensor unit associated with the container identifier. For example, the user device may retrieve a frequency associated with a container identifier from a server and tune to that frequency to receive a signal from the sensor unit. In some embodiments, the sensor unit and the user device may be paired with a standard pairing protocol such as Bluetooth protocol. In some embodiments, when a sensor unit is paired with a user device in step 210, a virtual checkout lane is opened for the sensor unit at a server to keep track of items scanned by the sensor unit. After step 201, a shopper may stow the user device in their pocket or bag until he/she is ready to checkout at step 207.

In step 202, a sensor of the sensor unit detects identifying information from an item gathered to be placed into a shopping container. As a shopper gathers items for purchase, he/she may touch each item at the sensor or pass the item near the sensor to provide item identifying information to the sensor unit. The sensor unit may be attached or integrated with the rim or the handle of the shopping container such that the shopper can have the sensor detect the item with one-hand before placing the item into the container. In some embodiments, the identifying information may be detected by scanning a bar code, a QR code, or a printed pattern, by reading a conductive ink pattern, RFID, a NFC, or a BTLE tag, or by taking a picture of the product packaging and/or product label.

In step 203, the transmitter of the sensor unit wirelessly transmits identifying information of the item detected in step 202 to the user device. The transmitter may transmit at a short-range radio frequency receivable by the user device. The transmitted signal may include a string of numbers and/or characters, such as a UPC, that is a unique identifier of a product for purchase. In step 203, the user device may passively receive the transmission while holstered or stowed in a pocket or a bag. In some embodiments, the user device may enter a stand-by mode in steps 203 with the shopping application running in the background to conserve energy. In some embodiments, after step 203, the identifying information of the item is not stored on the sensor unit.

In step 205, the user device builds a shopping list. The shopping application on the user device may add each item detected by the sensor unit in step 202 to a shopping list. In some embodiments, when the user device receives identifying information of an item, it retrieves additional information about the item from a server. For example, the sensor unit may provide a universal product code (UPC) to the user device. The user device may then query a server for one or more of a name, an image, a description, and a price for the item. The shopping list may be displayed with the retrieved information. For example, when a shopper takes out their user device to verify the items on the shopping list, the shopping list may display each item with one or more of item name, item image, and item price. The total price of items on the shopping list may also be determined and displayed based on the retrieved information. In some embodiments, in step 205, the user device relays received identifying information of an item to a server via a network and the shopping list is maintained on the server.

Steps 202, 203, and 205 may be repeated for each item a shopper gathers and places into the shopping container. In some embodiments, a user may have the option of editing the shopping list before step 207. For example, the user may add or remove items manually and/or apply discounts to the purchase through a user interface of the shopping application.

In step 207, the shopping list is processed for payment. In some embodiments, step 207 may be initiated by the user selecting a checkout option in the shopping application on the user device. The shopping application may determine a total amount due for the items in the shopping container based on the shopping list. The user may pay for the items through an online payment system. For example, the user may enter payment information (such as credit card, debit card, online wallet, etc.) or select a stored payment option to pay for the items on the shopping list. The shopping application may provide a confirmation to the shopper as proof of purchase for the shopper to exit the retail store with the items in the shopping container.

In some embodiments, checkout is initiated when the shopper uses an in-store checkout counter. Checkout may be initiated by touching the user device with the checkout counter or scanning the user device at the checkout counter to transfer either an identifier of the mobile device or the sensor unit to the POS. The shopping list may be directly transferred to the in-store checkout counter wirelessly from the user device or retrieved from a server. The shopper can then pay for the items through conventional methods such as cash, check, credit card, debit card, and gift card, without having to scan each of the items in the shopping container at the checkout counter.

After step 207, payment confirmation may be provided to the shopper electronically or conventionally. The container identifier may be disassociated from the user device upon completion of checkout. The shopper may return the shopping container to the store to be used by another shopper and paired with another user device.

Referring now to FIG. 3, a block diagram of a system for building a shopping list utilizing conductive ink pattern sensing technology is shown. The system includes a consumer product 310, a smart basket 301, a mobile device 340, and a checkout terminal 350.

The consumer product 310 includes a packaging 312 and a conductive ink pattern 314. The conductive ink pattern 312 may be directly printed on the packaging 312 or applied as a label with adhesive. The conductive ink pattern 312 generally comprises a printed circuit that produces a specific voltage signature with the resistance across the circuit when read by a conductive ink pattern reader. In some embodiments, the conductive ink pattern 315 and the conductive ink antenna 322 may be based on Touchcode technology developed by T+ink, Inc. or other similar technologies.

The smart basket 301 includes a sensor unit 320 and a shopping container 330. The sensor unit 320 includes a power source 329, a conductive ink antenna 322, a voltage meter 324, a voltage interpreter 326, and a transmitter 328. The conductive ink antenna 322 is configured to measure voltage resistance or conductivity across a circuit such as the conductive ink pattern 314. In some embodiments, the conductive ink antenna 322 may also be a conductive ink pattern readable by a capacitive touch screen of the mobile device 340 to provide a container identifier or a sensor unit identifier to the mobile device 340. The voltage meter 324 determines a voltage 43 reading when the conductive ink antenna 322 contacts the conductive ink pattern 314. The voltage interpreter 326 interprets the output of the voltage meter 324 to determine identifying information of the consumer product 310 as indicated by the conductive ink pattern 314. The transmitter 328 transmits the output of the voltage interpreter 326 to the mobile device 340. The power source 329 powers one or more of the conductive ink antenna 322, the voltage meter 324, the voltage interpreter 326, and the transmitter 328.

The shopping container 330 may be a shopping basket, a shopping cart, a shopping bin or the like. The sensor unit 320 may be attached to the shopping container 330 detachably or permanently. The sensor unit 320 may also be integrated or imbedded in the structure of the shopping container 330. The shopping container 330 is generally configured to serve as a conveyance of the consumer product 310 while a shopper shops in a store.

The mobile device 340 may be any mobile device such as a mobile phone, a Smartphone, a tablet computer, a wearable computer and the like. The mobile device 340 includes a virtual shopping cart 342, an application 344, and a device receiver 346. The device receiver 346 receives a signal sent by the transmitter 328 of the sensor unit 320. The received information is used by the application 344 to add items to the virtual shopping cart 342. The application 344 may be configured to add an item to the virtual shopping cart 342 each time the device receiver 346 receives an item identifying information from the transmitter 328. The virtual shopping cart 342 may generally be preferred to as a shopping list and the application 344 may be referred to as a shopping application.

The mobile device 340 may further include a capacitive touch screen configured to read a conductive ink pattern containing a sensor unit identifier or a container identifier on the sensor unit 320 or the shopping container 330. In some embodiments, the mobile device also includes a conductive ink antenna and/or a conductive ink pattern. The conductive ink pattern on a mobile device may be used to provide a mobile device identifier to the POS 356 during checkout. For example, a virtual shopping cart or shopping list associated with the mobile device may be stored on a server. A shopper may place the mobile device 340 in contact with a conductive ink antenna at the POS 356 to initiate the checkout process. The POS 356 may read the conductive ink pattern on the mobile device to retrieve the shopping list associated with the mobile device from the server.

The checkout terminal 350 includes item data 352, store systems 354, and POS 356. The checkout terminal 350 receives the virtual shopping cart 342 built by the application 344 of the mobile device 340 either directly or via a server. The item data 352 and the store systems 354 may provide price, discount information, and/or tax information to determine the total cost of the items in the virtual shopping cart. The POS 356 processes the payment for the content of the virtual shopping cart 342 and provides purchase confirmation. The POS 356 may be an online checkout system or an in-store checkout counter. In some embodiments, the POS 356 may be a conductive-ink enabled checkout counter. The POS 356 may physically contact or be near the mobile device 340 to receive a mobile device identifier and/or the shopping list from the mobile device 340.

In some embodiments, systems, apparatuses and methods are provided herein for building a shopping list using a sensor unit attached to a shopping container. In one embodiment, a shopping apparatus is provided. The shopping apparatus includes a portable item container and a sensor unit attached to the portable item container. The sensor unit includes a sensor configured to detect identifying information from items gathered by a user and placed in the portable item container and a transmitter configured to wirelessly transmit the identifying information of the items to a user device configured to use the identifying information to build a shopping list.

In one embodiment, a method for creating a shopping list is provided. The method includes the steps of detecting identifying information from items gathered by a shopper and placed in a portable item container with a sensor of a sensor unit attached to the portable item container, and wirelessly transmitting, with a transmitter of the sensor unit, the identifying information of the items to a user device configured to use the identifying information to build a shopping list.

In one embodiment, a sensor device is provided. The sensor device includes a sensor configured to detect identifying information from items gathered by a user and placed in a portable item container, a transmitter configured to wirelessly transmit the identifying information of the items to a user device configured to use the identifying information to build a shopping list, and an attachment means for attaching the sensor device to the portable shopping container.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A shopping apparatus comprising:
a portable item container; and
a sensor unit attached to the portable item container comprising:
a sensor configured to detect identifying information from items gathered by a user and placed in the portable item container; and
a transmitter configured to wirelessly transmit the identifying information of the items to a user device configured to use the identifying information to build a shopping list.

2. The shopping apparatus of claim 1, wherein the sensor unit further comprises:
a power source configured to supply power to at least one of the sensor and the transmitter.

3. The shopping apparatus of claim 1, wherein
the sensor comprises a voltage meter and a voltage interpreter, the voltage meter being configured to detect the identifying information of the items based on a conductivity of a conductive ink pattern applied to each of the items.

4. The shopping apparatus of claim 1, wherein the sensor comprises at least one of a bar code scanner, a Quick Response (QR) code reader, an optical scanner, a radio-frequency identification (RFID) reader, a near field communication (NFC) reader, a low energy Bluetooth (BTLE) reader, and a camera.

5. The shopping apparatus of claim 1, further comprising: a container identifier recognizable by the user device, wherein the container identifier comprises information the user device needs to receive the identifying information of the items from the transmitter.

6. The shopping apparatus of claim 1, wherein the portable item container comprises a receptacle portion and a handle portion, and the sensor unit is attached to one of the handle portion and a rim of the receptacle portion.

7. The shopping apparatus of claim 1, wherein the shopping list is configured to be processed for payment for the items gathered at a checkout terminal.

8. The shopping apparatus of claim 1, wherein the shopping list is configured to be processed for payment for the items gathered through an online payment system.

9. The shopping apparatus of claim 1, wherein the identifying information of an item is not stored on the sensor unit after transmission.

10. The shopping apparatus of claim 1, wherein the sensor unit is integrated with a portion of the portable item container.

11. The shopping apparatus of claim 1, wherein the sensor unit is detachable from the portable item container.

12. A method of creating a shopping list comprising:
detecting identifying information from items gathered by a shopper and placed in a portable item container with a sensor of a sensor unit attached to the portable item container; and
wirelessly transmitting, with a transmitter of the sensor unit, the identifying information of the items to a user device configured to use the identifying information to build the shopping list.

13. The method of claim 12, wherein the sensor unit further comprises a power source supplying power to at least one of the sensor and the transmitter.

14. The method of claim 12, wherein the sensor comprises a voltage meter and a voltage interpreter, the voltage meter being configured to detect the identifying information of the items based on a conductivity of a conductive ink pattern applied to each of the items.

15. The method of claim 12, wherein the sensor comprises at least one of a bar code scanner, a Quick Response (QR) code reader, an optical scanner, a radio-frequency identification (RFID) reader, a near field communication (NFC) reader, a low energy Bluetooth (BTLE) reader, and a camera.

16. The method of claim 12, wherein the portable item container further comprises a container identifier recognizable by the user device, wherein the container identifier comprises information the user device needs to receive the identifying information of the items from the transmitter.

17. The method of claim 12, wherein the portable item container comprises a receptacle portion and a handle portion, and the sensor unit is attached to one of the handle portion and a rim of the receptacle portion.

18. The method of claim 12, wherein the shopping list is configured to be processed for payment for the items gathered at a checkout terminal.

19. The method of claim 12, further comprising: authenticating with the user device prior to transmitting the identifying information of the item.

20. A sensor device comprising:
a sensor configured to detect identifying information from items gathered by a user and placed in a portable item container;
a transmitter configured to wirelessly transmit the identifying information of the items to a user device configured to use the identifying information to build a shopping list; and
an attachment means for attaching the sensor device to the portable item container.
